(19) United States
(12) Patent Application Publication
(10) Pub. No.: US 2010/0201633 A1
(43) Pub. Date: Aug. 12, 2010

(54) TOUCH SCREEN WITH IMPROVED OPTICAL PERFORMACE

(75) Inventors: Larry Steven Mozdzyn, Garland, TX (US); Benedict Kwong, Dallas, TX (US)

Correspondence Address: MARTIN & ASSOCIATES, LLC, P O BOX 548, CARTHAGE, MO, 64836-0548, US

(73) Assignee: OCULAR LCD INC., Richardson, TX (US)

(21) Appl. No.: 12/367,838

(22) Filed: Feb. 9, 2009

(51) Int. Cl. G06F 3/041

(52) U.S. Cl. 345/173

(57) ABSTRACT

An improved touch screen has enhanced optical performance and aesthetic quality. The sense electrodes and other traces on the touch screen are made less invisible to the user by substantially filling the space between the conductive traces or electrodes with isolated regions that match the light transmission characteristics of the electrodes. In capacitive and resistive touch screens, the space between ITO electrodes and other traces on the substrate is substantially filled with ITO to match the electrodes. The space between electrodes is preferably filled with isolated regions of ITO formed in a pattern. The isolated regions in the pattern may be shaped and the electrodes notched to create non-linear spaces to further reduce the visibility of the pattern. Further, the space between ITO traces can be filled with irregular-shaped ITO regions to further reduce the visibility of the space.

### BACKGROUND

1. Technical Field

The disclosure and claims herein generally relate to touch screens, and more specifically relate to a touch screen with improved optical performance by incorporating a fill pattern between the sense electrodes.

2. Background Art

Touch screens have become an increasingly important input device. Touch screens use a variety of different touch detection mechanisms. One important type of touch screen is the capacitive touch screen. Capacitive touch screens are manufactured via a multi-step process. In a typical touch screen process, a transparent conductive coating, such as indium tin oxide (ITO) is formed into conductive traces on two surfaces of glass. The conductive traces on the two surfaces of glass form a grid that can sense the change in capacitance when a user's finger or a pointer touches the screen. The published Patent Application No. 2008/0245582, filed Mar. 31, 2008 by Jared G. Bytheway, titled Floating Capacitive Couplers Used To Enhance Signal Coupling In A Capacitive Touchpad (incorporated herein by reference) teaches to use floating regions of ITO between conductive traces to improve electrical characteristics of the touch screen.

Another type of touch screen uses resistance to sense the location of touch on the screen. In a resistive touch screen, one set of sense electrodes is typically formed on a flexible surface. The touch by the user pressing on the flexible surface makes contact between two sets of electrodes. Electrical circuits sense the location of the touch based on the resistance of the electrodes to the point of contact.

In typical capacitive and resistive touch screens, the sense electrodes are formed with a layer of indium tin oxide (ITO) on a substrate. There are typically substantial non-conductive areas between the electrodes. The electrode traces in the ITO layer are substantially transparent when formed on a transparent substrate such as glass. However, since the ITO electrodes transmit and reflect light differently than substrate in the areas between the electrodes, the electrodes traces are somewhat visible to the user. The visibility of the electrode traces is distracting to the user. It would be desirable for the touch screen to have the sense electrodes and other traces on the touch screen to be substantially invisible to the user, thereby increasing the optical performance and aesthetic quality of the touch screen.

Without a way to reduce the visibility of sense electrodes in a touch screen, touch screens will continue to suffer from reduced optical performance and aesthetic quality.

### BRIEF SUMMARY

The application and claims herein are directed to an improved touch screen with enhanced optical performance and aesthetic quality. The sense electrodes and other traces on the touch screen are made less invisible to the user by substantially filling the space between the electrodes with isolated traces or regions that match the light transmission characteristics of the electrodes. In capacitive and resistive touch screens, the space between ITO electrodes and other traces on the substrate is substantially filled with ITO regions to match the electrodes. The space between electrodes is preferably filled with isolated regions of ITO formed in a geometric pattern. The isolated regions in the geometric pattern may be shaped to eliminate long lines of space to further reduce the visibility of the pattern. In addition, the edges of the electrodes may be notched and integrated with the geometric shapes to further eliminate long spaces between the electrodes. Further, the space between ITO traces can be filled with irregularly shaped ITO regions to further reduce the visibility of the space.

The description and examples herein are directed to capacitive touch screens and resistive touch screens that utilizes two substrates for the conductive sense electrodes, but the claims herein expressly extend to other arrangements including a single glass substrate.

The foregoing and other features and advantages will be apparent from the following more particular description, and as illustrated in the accompanying drawings.

### BRIEF DESCRIPTION OF DRAWINGS

The disclosure will be described in conjunction with the appended drawings, where like designations denote like elements, and:

FIG. 1 is a side view of a capacitive touch screen according to the prior art;

FIG. 2 is a bottom view of the bottom glass of the capacitive touch screen shown in FIG. 1;

FIG. 3 shows a top view of the top glass of the capacitive touch screen shown in FIG. 1;

FIG. 4 shows an enlarged view of a portion of the top glass shown in FIG. 3 according to the prior art;

FIG. 5 shows the same portion of the top glass shown in FIG. 4 with the area between the electrodes substantially filled with unconnected ITO regions;

FIG. 6 shows a side view of a resistive touch panel;

FIG. 7 shows a side view of the resistive touch panel shown in FIG. 7 as it is depressed by a user's finger;

FIG. 8 shows a portion of a resistive touch panel with the space between two sense electrodes substantially filled with unconnected ITO regions;

FIG. 9 shows a top view of the top layer of a resistive touch panel with a first electrode according to the prior art;

FIG. 10 shows a top view of the top layer of a resistive touch panel with a first electrode having areas between the electrodes substantially filled with unconnected ITO regions;

FIG. 11 shows a top view of the bottom layer of a resistive touch panel with a second electrode according to the prior art;

FIG. 12 shows a top view of the bottom layer of a resistive touch panel similar to FIG. 11 with a second electrode having areas between the electrodes substantially filled with unconnected ITO regions;

FIG. 13 shows a pattern of unconnected ITO regions shaped as circles filling the space between conductive traces;

FIG. 14 shows a zig-zag pattern of unconnected ITO regions filling the space between conductive traces; and

FIG. 15 shows a pattern of irregular-shaped ITO regions for filling the space between conductive traces.

### DETAILED DESCRIPTION

The description and claims herein are directed to an improved touch screen. The sense electrodes and other traces on the touch screen are made less invisible to the user by substantially filling the space between the traces with isolated regions of material that match the light transmission characteristics of the traces. In capacitive and resistive touch screens, the space between ITO electrodes and other traces on the substrate is substantially filled with ITO regions that match the optical characteristics of the electrodes.

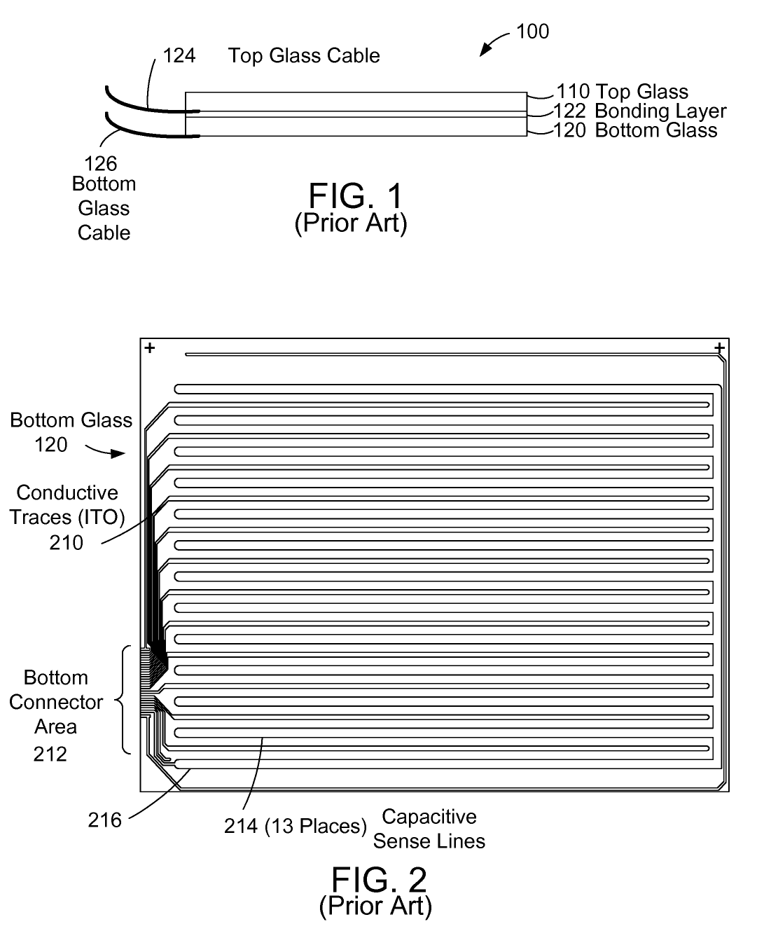

FIG. 1 shows a simplified side view of a capacitive touch screen 100 according to the prior art. The touch screen 100 has a top glass 110 and a bottom glass 120. The top glass 110 is bonded to the bottom glass 120 with a bonding layer 122. The top glass 110 has a top glass cable 124 that connects to conductive traces (not shown) on a portion of the bottom surface of the top glass 110. Similarly, bottom glass 120 has a bottom glass cable 126 that connects to conductive traces (not shown) on a portion of the bottom surface of the bottom glass 110. Alternatively, the conductive traces and the cables could be connected to the top side (not shown) on one or both pieces of glass. The conductive traces and other materials applied to the glass are not shown in this drawing for simplicity but are described further below.

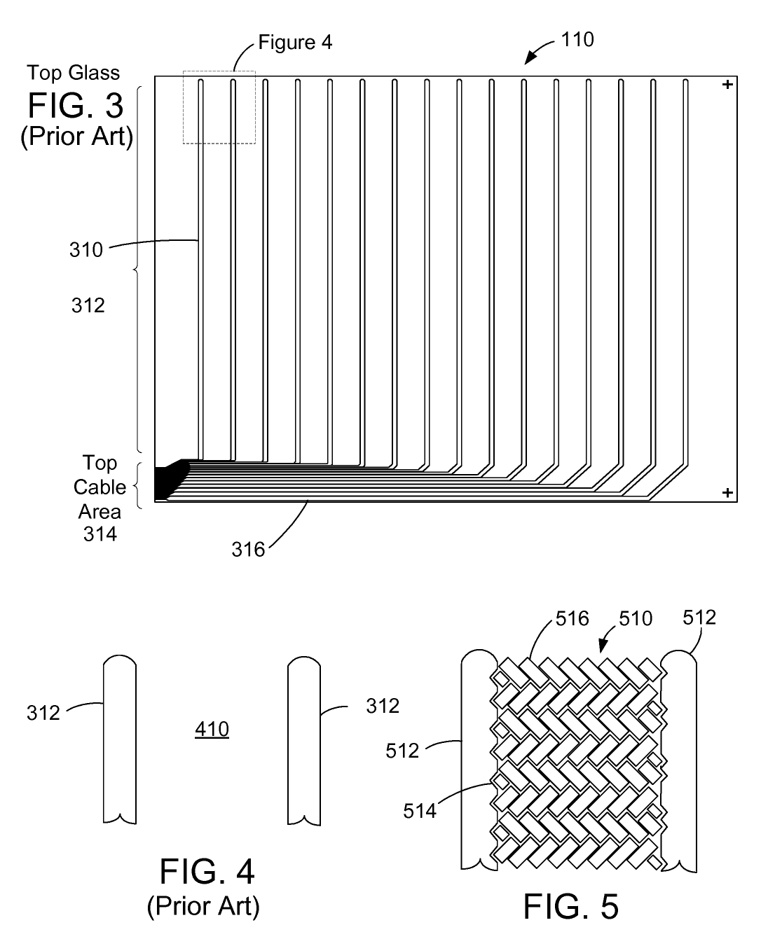

FIGS. 2 and 3 illustrate the two glass layers of the capacitive touch screen shown in FIG. 1. These two figures show the ITO layer formed on the glass that includes conductive traces and capacitive sense lines. The isolated regions added to the ITO layer for the top glass are shown in FIG. 4 and described further below. Similar isolated regions (not shown) are preferably formed in spaces on the bottom glass in the same manner as described for the top glass.

FIG. 2 illustrates the bottom side of the bottom glass 120 according to the prior art. The bottom glass 120 has conductive traces 210 of ITO in the horizontal direction. The horizontal conductive traces 210 together with the vertical traces of the top glass described below form a grid pattern. The conductive traces are gathered together in the bottom connector area 212 where a bottom glass cable 126 (FIG. 1) connects to the conductive traces 210 on the bottom glass 120. In addition, the bottom glass 120 has a set of capacitive sense lines 214 also formed of ITO that are interdispersed with the conductive traces 210. The capacitive sense lines 214 are all connected together on the right hand side of the drawing and the bottom sense line 216 extends to the bottom connector area 212 to connect to the bottom glass cable 126 (FIG. 1). The capacitive sense lines 214 are driven by the touch screen electronics (not shown) to sense the change in capacitance in the manner taught in the prior art.

FIG. 3 illustrates a top view of the top glass 110 according to the prior art after forming conductive traces 310 on the bottom surface of the top glass 110. The conductive traces 310 are formed of a conductive material such as indium tin oxide (ITO). The conductive traces 310 have a first section 312 in the viewing area of the touch screen and a second section 314 that typically will be placed outside the viewing area of the touch screen. The conductive traces 310 may be formed as known in the prior art. The typical prior art process includes the step of: forming an ITO layer on the glass, cleaning the glass, coating with photo resist, using ultra-violet light to expose the trace pattern on the resist, developing the photo resist, etching the ITO layer, removing the photo resist, and then cleaning the ITO layered glass. After these steps the top glass 110 appears as shown in FIG. 3.

Again referring to FIG. 3, each of the conductive traces 310 terminate in the area of the top cable area 316 where the top glass cable will be connected in the manner known in the prior art and as illustrated in FIG. 1. The conductive traces on the top glass 110 are in the vertical direction and the conductive traces on the bottom glass 120 are perpendicular and lie in a horizontal plane as shown in FIG. 2. When these two pieces of glass are bonded together, the traces on the two pieces of glass form a grid that allows the electrical circuits (not shown) that drive the conductive traces to sense the location where the glass is touched. There are various ways known in the prior art to sense the location where the screen is touched using the grid of conductive traces.

FIG. 4 shows a portion of the top glass show in FIG. 3 and described above with reference to the prior art. In FIG. 4, the space 410 between the conductive traces 312 is not covered with ITO according to the prior art. The conductive traces 312 represent capacitive sense lines, sense electrodes or other ITO traces on the touch screen.

FIG. 5 shows the same portion of the top glass shown in FIG. 4. Note that the conductive traces 512 are similar in some respects to the prior art conductive traces 312 shown in FIGS. 3 and 4. In FIG. 5, the area 510 between the conductive traces 512 on the visible portion of the touch screen is substantially filled with unconnected or isolated ITO regions 516 in a pattern. The isolated ITO regions 516 preferably fill about 75 percent, or more preferably 80 percent or greater of the area between the conductive traces. Preferably, the isolated ITO regions 516 are fabricated with the same manufacturing step as the sense electrodes by adding the isolated ITO regions to the pattern used to create the ITO layer. When the space between the conductive traces is substantially filled with isolated ITO regions, the space then has the same optical characteristics as the conductive traces. This space is then less visible to the naked eye in the finished touch screen. The ITO regions are preferably isolated (not interconnected), but some or all of the regions could be connected in a capacitive touch screen as taught in the Bytheway patent application cited above.

FIG. 5 further shows that the ITO regions 516 are square shaped and arranged in a simple pattern such that the spaces between the ITO regions 516 are non-linear between the conductive traces. This means that any space between isolated regions taken from the top to bottom or from the left to the right between the conductive traces forms a broken or non-linear line. Any line formed by the space between isolated regions is broken up by adjacent ITO regions such that there is no straight, continuous space between the conductive traces. A pattern of ITO regions with a non-linear space between the conductive traces increases the visual quality of the touch screen by reducing the size of continuous features such that they are less visible to the naked eye. In the illustrated example, the ITO regions are rectangular, “brick” shaped regions arranged in a herringbone pattern similar to that used in laying bricks. Other shapes and patterns could also be used where the result is to provide a non-linear space between the ITO regions to improve the optical performance.

FIG. 5 further shows that the ITO regions 516 are integrated with the conductive traces 512 to further reduce any long spaces between the ITO regions 516 and the conductive traces 512. The conductive traces 512 are notched 514 with a pattern to match the pattern of the ITO regions 516 to allow a portion of the ITO regions near the conductive traces to penetrate into the edge of the sense electrode but not make contact with the sense electrode. Integrating the pattern of ITO regions into the conductive traces increases the visual quality of the touch screen by reducing the size of the linear space that would otherwise be at the edge of the sense electrode, where reducing the size of the linear spaces makes the space less visible to the naked eye.

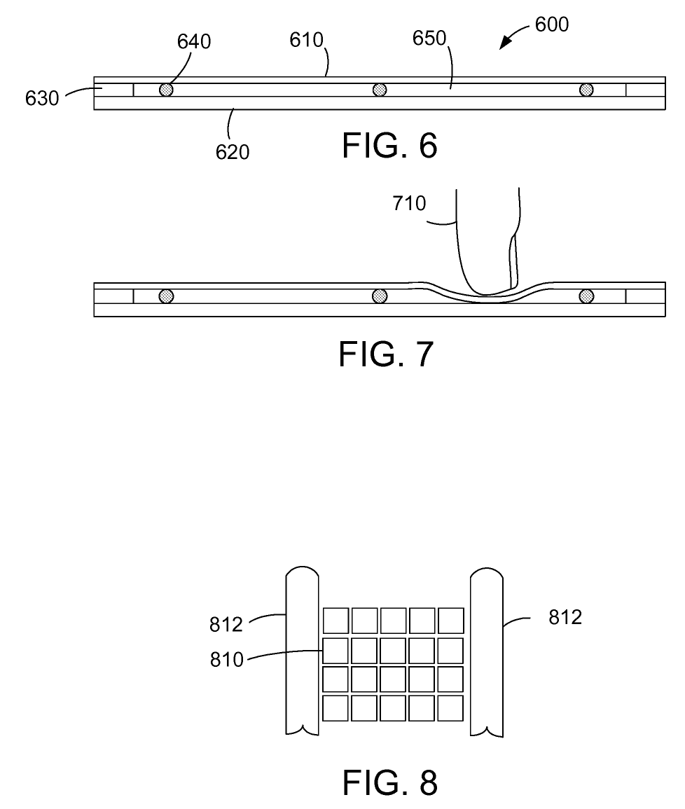

FIG. 6 illustrates a cross-sectional side view of a resistive type touch screen 600. The resistive touch screen 600 includes a flexible top layer 610 bonded to a rigid bottom layer 620 with a bonding adhesive 630 around the edges of the touch screen. The top layer 610 is separated from physical contact with the bottom layer 620 by a number of spacers 640. The spacers form a gap 650 between the top layer 610 and bottom layer 620. The top layer 610 is typically formed of a flexible polyester film such as Mylar® made by Dupont Teijin Films. The bottom layer is a rigid layer typically made of glass. The bottom side of the top layer 610 and the top side of the bottom layer 620 is covered with conductive traces of ITO to form sense electrodes in the same manner as described above for the sense lines and conductive traces used in capacitive touch screens. Thus there are sense electrodes on the two opposing faces of the air gap 650. The sense electrodes are connected to electronic circuitry with connecters in a similar manner as shown in FIG. 1, which is well known in the prior art. When a user presses on the touch screen, as represented by a finger 710 pressing the touch screen in FIG. 7, the mechanical deformation of the top layer allows contact of the sense electrodes on the opposing faces of the touch screen top and bottom layers. The electrical circuitry (not shown) is then able to determine the location of the contact depending on which electrodes are connected together. Various methods for sensing the electrodes are well known in the prior art.

FIG. 8 illustrates an example of substantially filling the space between the sense electrodes of a resistive touch screen with isolated regions that match the light transmission characteristics of the electrodes. Note that the conductive traces 812 are similar in some respects to the prior art conductive traces 312 shown in FIGS. 3 and 4. The sense electrodes 312 shown in FIG. 8 represent the sense electrodes on either the top layer 610 or the bottom layer 620 shown in FIG. 6 and described above. The area between the sense electrodes is preferably filled with isolated regions of ITO to improve the optical characteristics of the resistive touch screen in the same manner as discussed above for the capacitive touch screen. In resistive touch screens, it is important that the size of the isolated regions is small in comparison to the size of the sense electrodes so that they do not affect the resolution of the touch screen. Substantially filling the space between the sense electrodes means the isolated regions preferably cover about 75 percent, or more preferably 80 percent or greater of the space between the sense electrodes. The resistive touch screen may also incorporate a pattern of the isolated regions with non-linear spaces and integrated sense electrodes as shown in FIG. 5 and described above.

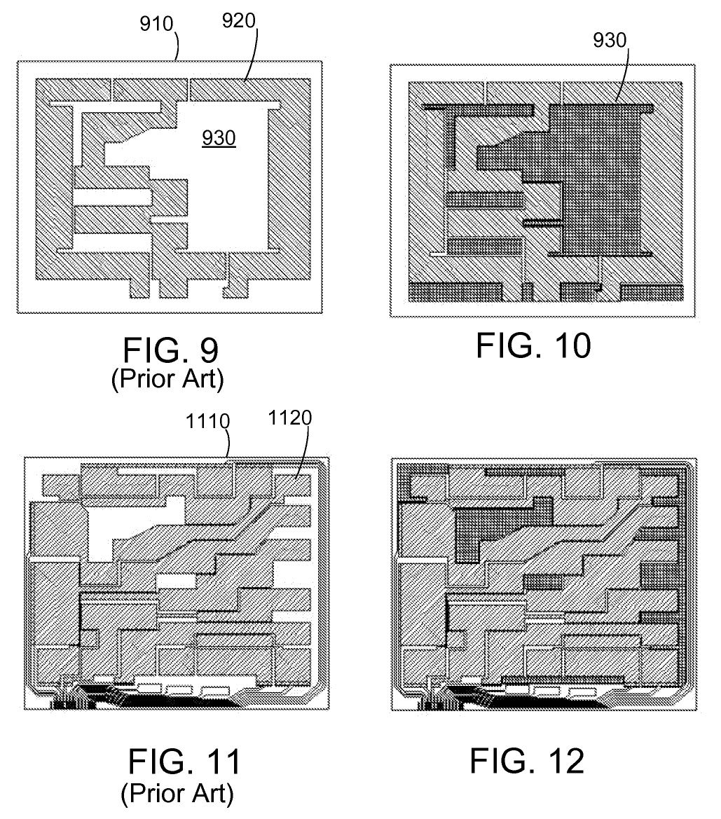

FIGS. 9-12 illustrate another example of the space between sense electrodes substantially filled with ITO regions as described herein. FIGS. 9 and 11 represent sense electrodes on the top and bottom layers of a resistive touch screen according to the prior art. FIG. 9 represents a top view of a flexible top layer 910 with a pattern of sense electrodes 920 as they would appear on the bottom side of the top layer viewed from the top. Or, in other words, FIG. 9 shows the pattern of sense electrode as viewed from the top on a top layer of transparent polyester film. Similarly, FIG. 11 represents a top view of a rigid bottom layer 1110 with a pattern of sense electrodes 1120 as they would appear from above. When the two layers show in FIGS. 9 and 11 are bonded together in the manner shown in FIG. 6, the resulting touch screen can discern the location of touch in any region where there is an overlap of sense electrodes on the top and bottom layers. In this example the touch locations on the screen, the regions where the two layers overlap, are not a grid as described in the previous examples. The touch screen pattern shown here is a specific pattern for a specific touch screen application. A resistive touch screen could use a grid pattern similar to the capacitive examples described above. In FIGS. 9 and 11, the spaces between the electrodes are those areas of the top and bottom layers that are not covered by sense electrodes. The space between the electrodes is typically the bare substrate of flexible polyester film or glass respectively. For example, in FIG. 9 there is a large space 930 on the top layer. This space is filled with isolated regions of ITO as shown in FIG. 10 and described below.

FIGS. 10 and 12 represent the top and bottom layers for the same resistive touch screen shown in FIGS. 9 and 11 except that the space between the sense electrodes is substantially filled with isolated regions of ITO as described herein. For example, the space 930 in FIG. 9 is now substantially filled with isolated regions of ITO as shown in FIG. 10. The other spaces in the top layer are similarly filled as shown in FIG. 10, and the spaces between the electrodes of the bottom layer in FIG. 11 are filled with isolated regions of ITO as shown in FIG. 12.

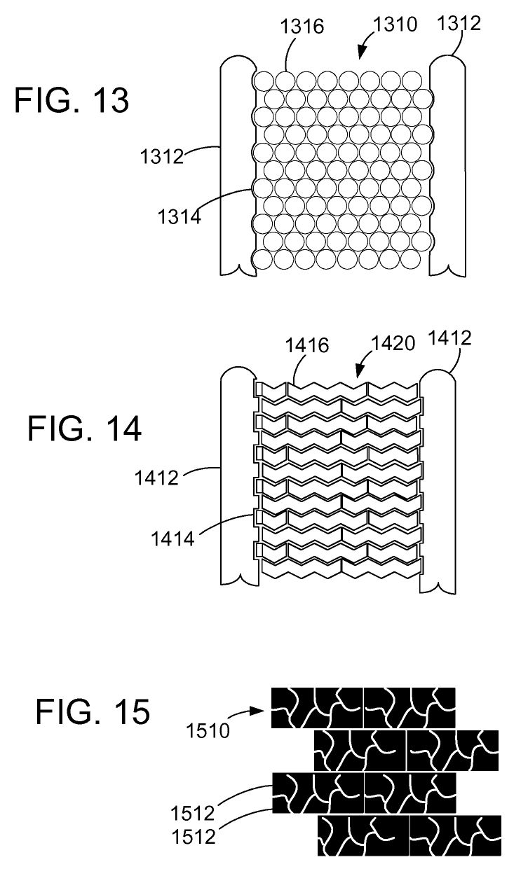

FIGS. 13 through 15 illustrate other examples of the space between conductive traces or sense electrodes substantially filled with ITO regions as described herein. FIG. 13 and 14 are similar to FIG. 5 described above. FIG. 13 shows a pattern of round shaped ITO regions 1316 that fill a space 1310 between sense electrodes 13 12. The ITO regions 1316 are integrated with the conductive traces 1312 by using a notched pattern 1314 on the conductive traces to match the pattern of the ITO regions 1316 to allow a portion of the ITO regions 1316 near the conductive traces 1312 to penetrate into the edge of the conductive traces or sense electrode as described above. Similarly, FIG. 14 shows a pattern of ziz-zag geometric shaped ITO regions 1416 that fill a space 1420 between sense electrodes 1412. The ITO regions 1416 are integrated with the conductive traces 1412 by using a notched pattern 1414 on the conductive traces 1412 to match the pattern of the ITO regions 1416. FIG. 15 illustrates another pattern of ITO regions for filling the space between conductive traces or sense electrodes. FIG. 16 illustrates a pattern of regularly shaped regions 1510 that comprise a number of irregularly shaped regions 1512 of ITO. In another variation, the entire space between the sense electrodes could be filled with irregularly shaped regions 1512 that are not part of a regular shaped region. Other shapes of ITO regions could similarly be used to substantially fill the spaces as described herein. These other shapes could include simple geometric shapes as well as more complex shapes that when formed in a pattern, have non-linear spaces between the adjacent regions in the pattern in the manner described herein.

One skilled in the art will appreciate that many variations are possible within the scope of the claims. Thus, while the disclosure has been particularly shown and described above, it will be understood by those skilled in the art that these and other changes in form and details may be made therein without departing from the spirit and scope of the claims.

1. A touch screen comprising:
a plurality of conductive traces formed on a surface with a space between at least two of the plurality of conductive traces;
a plurality of isolated regions that substantially fills the space between the at least two conductive traces where the plurality of isolated regions are formed of the same material as the conductive traces; and
wherein the plurality of isolated regions are formed in a pattern, where the pattern creates a space between adjacent ITO regions that is non-linear across the space between the at least two conductive traces.

2. The touch screen of claim 1 wherein the at least two conductive traces include notches in at least one edge to match the pattern of the isolated regions and the isolated regions are integrated into the notches.

3. The touch screen of claim 1 wherein the plurality of conductive traces and the plurality of isolated regions are formed of indium tin oxide (ITO).

4. The touch screen of claim 1 wherein the pattern is chosen from the following: a herringbone pattern, a zig-zag pattern, and a pattern of circles.

5. The touch screen of claim 1 wherein the touch screen is a capacitive touch screen and the conductive traces are formed on a glass surface.

6. The touch screen of claim 1 wherein the touch screen is a resistive touch screen and the conductive traces are formed on a flexible polyester film.

7. The touch screen of claim 1 wherein the plurality of isolated regions are irregularly shaped regions of indium tin oxide (ITO).

8. The touch screen of claim 1 wherein the plurality of isolated regions are regularly shaped regions of indium tin oxide (ITO) that comprise a plurality of irregularly shaped regions.

9. A touch screen comprising:
a plurality of conductive traces formed of indium tin oxide (ITO) on a surface with a space between at least two of the plurality of conductive traces;
a plurality of isolated regions that substantially fills the space between the at least two conductive traces where the plurality of isolated regions are irregularly-shaped and formed of indium tin oxide (ITO); and
wherein the plurality of isolated regions are formed in a pattern, where the pattern creates a space between adjacent ITO regions that is non-linear across the space between the at least two conductive traces; and
wherein the at least two conductive traces include notches in at least one edge to match the pattern of the isolated regions and the isolated regions are integrated into the notches.

10. A resistive touch screen comprising:
a plurality of conductive traces formed on a glass surface of the resistive touch screen with a space between at least two of the plurality of conductive traces; and
a plurality of isolated regions that substantially fills the space between the at least two conductive traces where the plurality of isolated regions are formed of the same material as the conductive traces.

11. The resistive touch screen of claim 10 wherein the plurality of isolated regions are formed in a pattern, where the pattern creates a space between adjacent ITO regions that is non-linear across the space between the at least two conductive traces.

12. The resistive touch screen of claim 11 wherein the at least two conductive traces include notches in at least one edge to match the pattern of the isolated regions and the isolated regions are integrated into the notches.

13. The resistive touch screen of claim 11 wherein the pattern is chosen from the following: a herringbone pattern, a zig-zag pattern, and a pattern of circles.

14. The resistive touch screen of claim 10 wherein the plurality of conductive traces and the plurality of isolated regions are formed of indium tin oxide (ITO).

15. The resistive touch screen of claim 10 wherein the plurality of isolated regions are irregularly shaped regions of indium tin oxide (ITO).

16. The resistive touch screen of claim 10 wherein the plurality of isolated regions are regularly shaped regions of indium tin oxide (ITO) that comprise a plurality of irregularly shaped regions.
